(19) United States
(12) Patent Application Publication
(10) Pub. No.: US 2012/0022410 A1
(43) Pub. Date: Jan. 26, 2012

(54) KNEE EXTENSION THERAPY DEVICE

(76) Inventor: Clyde Peach, Indianapolis, IN (US)

(21) Appl. No.: 13/190,028

(22) Filed: Jul. 25, 2011

Related U.S. Application Data
(60) Provisional application No. 61/367,683, filed on Jul. 26, 2010.

(51) Int. Cl. A61H 1/02

(52) U.S. Cl. 601/5

(57) ABSTRACT

An apparatus and method for performing knee extension therapy by applying an upward force to a supported distal region of a user's leg is provided. The apparatus further provides for patient use without the need for assistance.

### PRIORITY

The present application claims the benefit of U.S. Provisional Application No. 61/367,683 titled Knee Extension Therapy Device, filed on Jul. 26, 2010, the disclosure of which is expressly incorporated herein by reference.

### FIELD

The present disclosure relates to an apparatus and a method for knee extension therapy. More specifically the present disclosure relates to an apparatus and a method for facilitating the extension of a patient's knee by imparting an increase in elevation to the distal leg region of the patient.

### BACKGROUND ART

Knee extension therapy is an important treatment for individuals preparing for or recovering from knee surgery and in some instances may be utilized by knee injury patients in lieu of surgery. Knee extension therapy provides stretching, flexibility, and strengthening treatments important in aiding the recovery of knee surgery and knee injury patients. Often physical therapy professionals begin knee extension therapy with patients promptly after surgery to maintain knee joint flexibility, reduce scar tissue, and reduce knee joint inflammation. In many instances physical therapy and other medical professionals recommend that knee surgery and knee injury patients continue knee extension therapy on their own for a period of time. Patient adherence to the recommended knee extension therapy is often important in reducing patient recovery time following knee surgery or a knee injury and for the patient regaining optimal knee joint flexibility and function.

Knee extension therapy is generally initiated by a physical therapy professional with patients during hospitalization and often continued in out-patient treatment. However, it is regularly recommended that patients continue knee extension therapy treatments on their own, sometimes several times a day, when no physical therapy professional is available for assistance.

### SUMMARY

The present disclosure involves an apparatus and a method for facilitating the extension of a patient's knee by imparting an increase in elevation to the distal leg region of the patient.

According to one embodiment of the present disclosure, a knee therapy apparatus for performing knee extension of a user's leg by imparting increased elevation on a distal region of the user's leg is provided. The apparatus comprising a base having a patient proximal end, a patient distal end, an upper surface, a lower surface, a first side, and a second side; at least one strap assembly having a strap portion, a leg containment cushion, and a fastening means, wherein the at least one strap assembly is affixed to at least one of the first side, the second side, the upper surface, or the lower surface of the base. The apparatus further comprising an inflatable bladder having a balder and a pump wherein the pump is positioned within relation to the bottom surface of the distal leg receiving unit such that when the bladder is filled an upward force is applied to the distal region of the user's leg received within the distal leg receiving unit; and also comprising a distal leg elevation unit having a post unit and a leg support unit, wherein the post unit has an upper region, a lower region, an outer post, and inner post and a affixation means for affixing to the base and further wherein the leg support unit includes a distal leg receiving unit having a plurality of side surfaces and a bottom surface.

Additional features of the present disclosure will become apparent to those skilled in the art upon consideration of the following detailed description of the illustrative embodiment.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a plan view of a knee extension therapy device;

FIG. 1a is a plan view of a patient proximal end of a base of the device of FIG. 1;

FIG. 2 is a perspective view of a leg support unit of the device of FIG. 1;

FIG. 3 is a perspective view of an alternate embodiment of leg support unit; and

FIG. 4 is a plan view of a knee extension therapy device.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

### DETAILED DESCRIPTION OF THE DRAWINGS

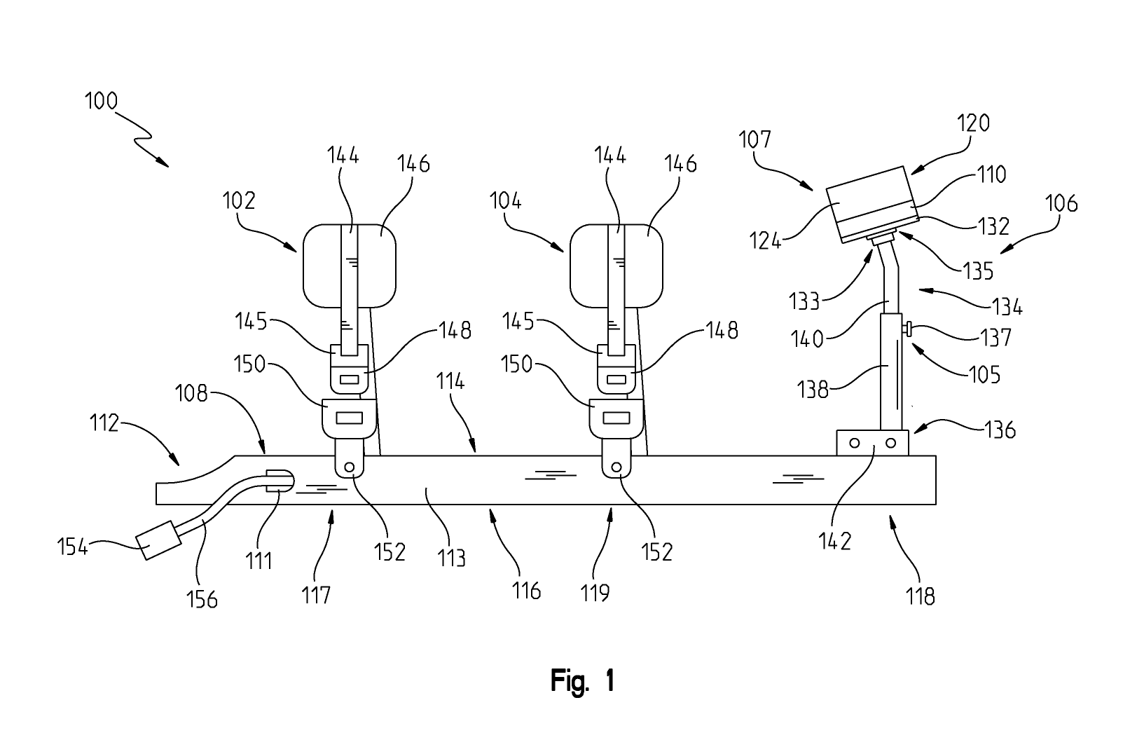

Referring to FIG. 1, knee extension therapy device 100 is illustrated as having proximal leg strap assembly 102, distal leg strap assembly 104, foot elevation unit 106, base 108, and inflatable bladder 110.

FIG. 1 further illustrates base 108 including upper surface 114, lower surface 116, first side 113, second side 115 (see FIG. 1a), patient proximal end 117, center region 119, and patient distal end 118. In the illustrated embodiment, first side 113 of base 108 is illustrated as defining opening 111 and patient proximal end 117 of base 108 is illustrated as defining seat 112. Although FIG. 1 illustrates patient proximal end 117 of base 108 as defining seat 112 it should be appreciated that seat 112 may take various forms, including being a separate attachment for knee extension therapy device 100.

Proximal leg strap assembly 102 and distal leg strap assembly 104 are illustrated in FIG. 1 including strap 144, strap adjustment member 145, leg containment cushion 146, buckle male member 148, buckle female member 150, female member mounting portion 152, and male member mounting portion 153 (see FIG. 1a). As depicted in the present embodiment, proximal leg strap assembly 102 is at or near patient proximal end 117 of base 108 and distal leg strap assembly 104 is positioned at or near center region 119 of base 108. The illustrated embodiment of FIG. 1a depicts strap 144 coupled to male member mounting portion 153, and affixed to second side 115 of base 108. Buckle female member 150, depicted in FIG. 1, is coupled to female member mounting portion 152 which is affixed to first side 113.

Furthermore, FIG. 1 illustrates strap 144 coupled to leg containment cushion 146. It is envisioned that strap 144 is connected to leg containment cushion 146 through any common means such as strap 144 being sewn to leg containment cushion 146 or strap 144 fitting into a plurality of loops (not depicted) which are part of leg containment cushion 146 or even by way of hook and loop fasteners (not depicted) coupled to strap 144 and leg containment cushion 146 respectively.

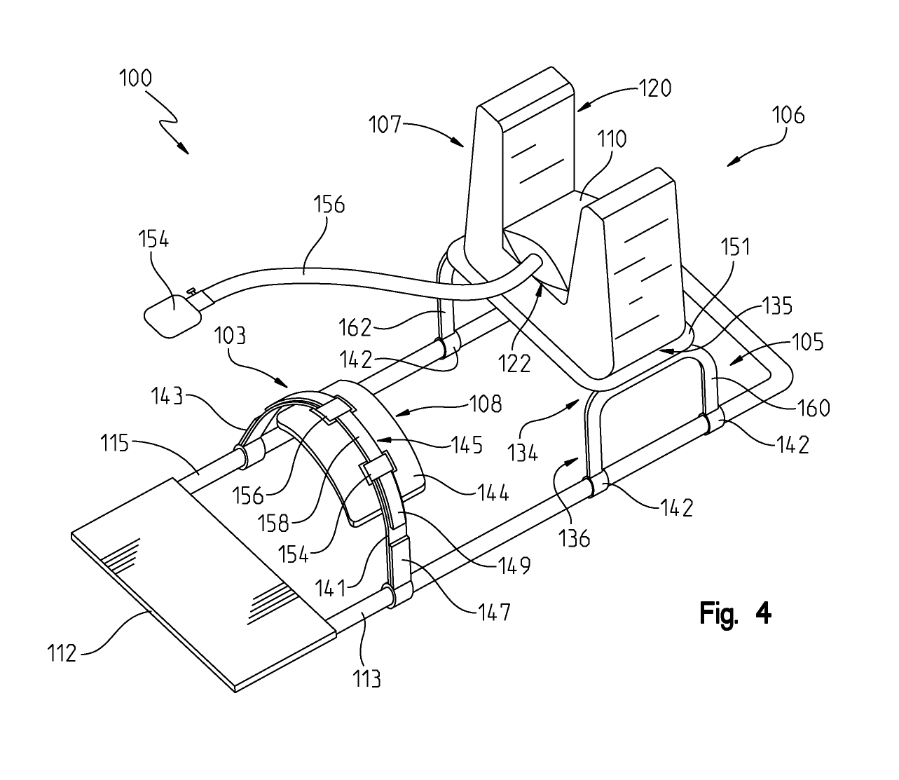

Referring next to FIG. 4, knee extension therapy device 100 is illustrated having only one leg strap assembly 103. Leg strap assembly 103, as illustrated, includes first strap 141, second strap 143, strap adjustment member 145, and leg containment cushion 146.

Strap adjustment member 145 is illustrated as including first metal loop 154, second metal loop 156, and attachment portion 158. Attachment portion 158 is connected to leg containment cushion 146 through any common means such as attachment portion 158 being sewn to leg containment cushion 146 or by way of hook and loop fasteners. As depicted, first metal loop 154 and second metal loop 156 are secured to opposing ends of attachment portion 158.

FIG. 4 further illustrates first strap 141 including lower portion 147 and upper portion 149. Lower portion 147 loops around first side 113 of base 108 and is affixed to a portion of first strap 141 on the opposing side of first side 113 such that first strap 141 is retained on first side 113 of base 108. It is envisioned that lower portion 147 is affixed to a portion of first strap 141 through any common means such as being sewn to first strap 141 or by way of hook and loop fasteners. As further depicted in FIG. 4, upper portion 149 of first strap 141 loops through first metal loop 156 of strap adjustment member 145 and reversibly attaches to a portion of first strap 141 on the opposing side of strap adjustment member 145 via hook and loop fasteners. Second strap 143 operates in relation to second side 115 of base 108 and second metal loop 156 of strap adjustment member 145 in the same manner as first strap 141. Accordingly, upper portions 149 of first strap 141 and second strap 143 provide infinite adjustment and positioning of strap adjustment member 145.

Continuing with FIG. 4, it should be appreciated that positioning of leg strap assembly 103 with relation to base 108 can be adjusted by sliding lower portion 147 of first strap 141 along first side 113 and sliding lower portion 147 of second strap 143 along second side 115.

Returning to FIG. 1, foot elevation unit 106 is shown having post unit 105, leg support unit 107, and affixation bracket 142. Post unit 105 includes outer post 138, inner post 140, upper region 134, lower region 136, and mounting member 133. As illustrated in the present embodiment, affixation bracket 142 mounts lower region 136 of post unit 105 to upper surface 114 of base 108 at or near patient distal end 118 of base 108. In the illustrated embodiment, inner post 140 is received within outer post 138.

Outer post 138 includes post height adjuster 137. Upon inner post 140 being received within outer post 138, post height adjuster 137 engages both outer post 138 and inner post 140 to secure the position of inner post 140 relative to outer post 138. In the present embodiment inner post 140 is further illustrated as being angled, although it should be appreciated that inner post 140 may also be straight or curved.

Mounting member 133 may be removably coupled or permanently affixed to post unit 105. As illustrated in FIG. 1, mounting member 133 is coupled to inner post 140 at upper region 134 of post unit 105.

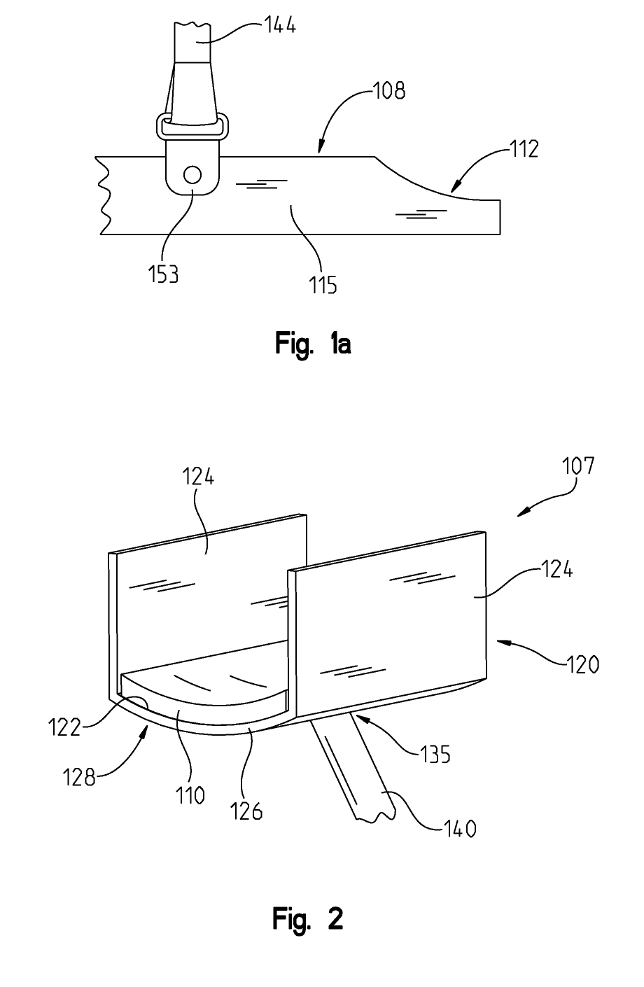

Referring to FIG. 2, leg support unit 107 is illustrated as including leg receiving unit 120, mounting region 135, and inflatable bladder 110. Leg receiving unit 120 is further illustrated as comprising receiving unit bottom member 126 and a plurality of receiving unit side members 124. Receiving unit bottom member 126 further includes support surface 122.

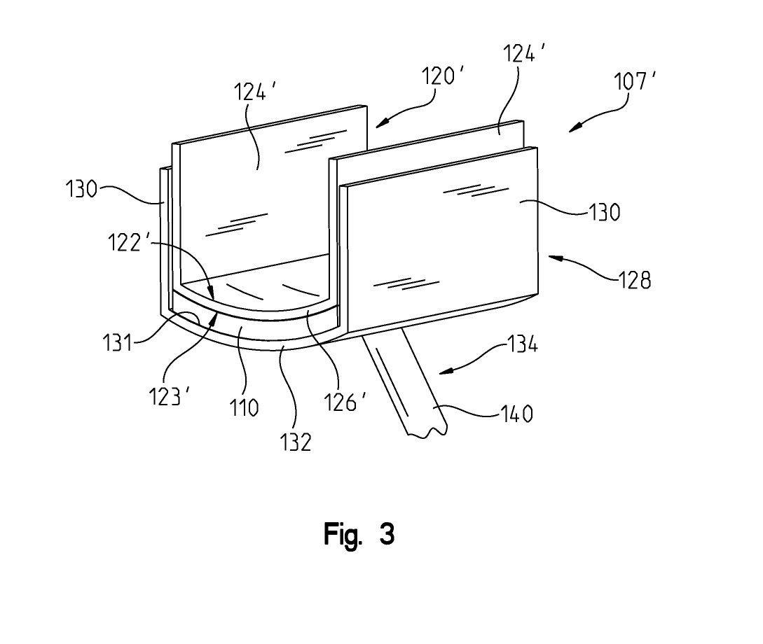

Moving briefly to FIG. 3, an embodiment of leg support unit 107 is illustrated as including framing bracket 128, leg receiving unit 120′, and mounting region 135. Leg receiving unit 120′ includes a plurality of receiving unit side members 124′ and receiving unit bottom member 126′. Receiving unit bottom member 126′ further includes support surface 122′ and under surface 123′. Framing bracket 128 is illustrated including framing bracket side members 130 and framing bracket bottom member 132. Framing bracket bottom member 132 includes upper surface 131. Furthermore, while not pictured, embodiments of leg support unit 107 are envisioned where receiving unit side members 124′ and framing bracket side members 130 have matching tracks thereon that maintain a vertical alignment of leg receiving unit 120′ and framing bracket 128.

Returning briefly to FIG. 1, mounting member 133 affixes leg support unit 107 at mounting region 135 to post unit 105. As illustrated in the present embodiment mounting member 133 couples to upper region 134 of inner post 140 and engages leg support unit 107 at mounting region 135.

Returning to FIG. 2, inflatable bladder 10 is positioned on support surface 122 of receiving unit bottom member 126. In the illustrated embodiment, inflatable bladder 110 is shown extending approximately the length and width of support surface 122, however it should be appreciated that variations in which inflatable bladder 110 extends only a portion of support surface 122 are envisioned.

The embodiment of FIG. 3 illustrates inflatable bladder 110 positioned between framing bracket 128 and leg receiving unit 120′. Inflatable bladder 110 is shown contacting upper surface 131 of framing bracket bottom member 132 and as contacting under surface 123 of receiving unit bottom member 126′ of leg receiving unit 120′. As illustrated, inflatable bladder 110 separates framing bracket bottom member 132 from receiving unit bottom member 126.

Returning to the embodiment of knee extension therapy device 100 illustrated in FIG. 4, foot elevation unit 106 is shown including post unit 105, leg support unit 107, and a plurality of affixation brackets 142. Post unit 105 includes first foot support 160 and second foot support 162. Both first foot support 160 and second foot support 162 include upper region 134 and lower region 136. As illustrated, plurality of affixation brackets 142 mount lower region 136 of first foot support 160 to first side 113 of base 108 and mount lower region 136 of second foot support 162 to second side 115 of base 108.

In the illustrated embodiment of FIG. 4, plurality of affixation brackets 142 maintain positioning of first foot support 160 and second foot support 162 to first side 113 and second side 115, respectively, via friction fit. Positioning of first foot support 160 and second foot support 162 along first side 113 and second side 115, respectively, can be adjusted by applying a force to plurality of affixation brackets 142, in the direction of the desired adjustment which overcomes the force of the friction fit of plurality of affixation brackets 142. Furthermore, while a friction fit plurality of affixation brackets 142 are disclosed, embodiments are envisioned that utilize other typical affixation brackets including bolts, screws, and spring loaded protuberances.

The embodiment of foot elevation unit 106, illustrated in FIG. 4, depicts leg support unit 107 including mounting region 135 and leg receiving unit 120. Mounting region 135, as illustrated, includes platform 151 coupled to upper region 134 of first foot support 160 and second foot support 162. Leg receiving unit 120 includes support surface 122 and, in the illustrated embodiment, is reversibly coupled to platform 151 via hook and loop fasteners, although alternate means of coupling leg receiving unit 120 to platform 151 are envisioned.

Furthermore, the embodiment depicted in FIG. 4 illustrates inflatable bladder 110 positioned on support surface 122 of leg receiving unit 120. Inflatable bladder 110 may be affixed to support surface 122 of leg receiving unit 120 by hook and loop fasteners. In the illustrated embodiment, inflatable bladder 110 is shown extending approximately the length and width of support surface 122, however it should be appreciated that variations in which inflatable bladder 110 extends only a portion of support surface 122 are envisioned.

The embodiments illustrated herein present inflatable bladder 110 having inflatable bladder control unit 154 and cord 156. Cord 156 operatively connects inflatable bladder control unit 154 to inflatable bladder 110. As illustrated in FIG. 1, cord 156 may enter base 108 at opening 111. However, embodiments such as illustrated in FIG. 4 in which cord 156 is entirely outside base 108 exist. Further, although the embodiments presented herein depict inflatable bladder 110 as including a manual inflatable bladder 110 controlled by inflatable bladder control unit 154, such as a hand pump, it should be appreciated that inflatable bladder 110 may alternatively include an electric or motorized pump unit (not shown) in which inflatable bladder control unit 154 is operatively connected by cord 156 to the electric pump for inflating inflatable bladder 110.

Having described the various portions of knee extension therapy device 100, the operation thereof will now be discussed. Referring to FIG. 1, a patient (not shown) may first desire to adjust the height of leg support unit 107 to a desired level. A patient accomplishes a change in the height of leg support unit 107 by securing inner post 140 at a desired height within outer post 138 using post height adjuster 137. Alternatively, a caregiver may pre-set the height of leg support unit 107. However, as depicted in the embodiment of knee extension therapy device 100 in FIG. 4, the height of leg support unit 107 may be fixed.

After securing leg support unit 107 at a desired height, patient engages a proximal portion of their leg with base 108 at seat 112 such as by sitting thereon. The user places the distal portion of the patient's leg requiring extension therapy, such as the ankle or foot, within leg receiving unit 120. The distal portion of patient's leg is allowed to rest on support surface 122 of leg receiving unit 120 (FIG. 3) or directly on inflatable bladder 110 (FIG. 2 and FIG. 4).

Referring to FIG. 4, the patient may find it necessary to adjust the positioning of foot elevation unit 106 in relation to base 108. With regard to the embodiment of knee extension therapy device 100 illustrated in FIG. 4, a change in the positioning of foot elevation unit 106, in relation to base 108, is accomplished by applying a force to plurality of affixation brackets 142 (in the direction of the desired adjustment) which overcomes the force of the friction fit of plurality of affixation brackets 142.

Once the leg is positioned on knee extension therapy device 100, the patient may find it necessary to adjust proximal leg strap assembly 102 and distal leg strap assembly 104 (FIG. 1) or leg strap assembly 103 (FIG. 4) such that leg strap assemblies 102, 103, 104 maintain the positioning of the proximal region and central region of patient's leg during leg extension therapy. Leg strap assemblies 102, 103, 104 may be adjusted by either increasing or decreasing the length of strap 144 through strap adjustment member 145 such that leg strap assemblies 102, 103, 104 snugly hold the leg to knee extension therapy device 100. 102, 103, 104.

Further, positioning of leg strap assembly 103 as illustrated in FIG. 4 with respect to base 108, may be achieved by sliding first strap 141 and second strap 143 along first side 113 and second side 115 of base 108, respectively. A patient may find it preferable to place the distal portion of patient's leg within leg receiving unit 120 and place leg containment cushion 146 over patient's leg prior to adjusting leg strap assemblies 102, 103, 104.

Referring to FIG. 1, once leg strap assemblies 102, 104 are adjusted such that the positioning of the proximal region and central region of patient's leg remains relatively unchanged during leg extension therapy, buckle male member 148 is fastened to buckle female member 150. Patient may find that leg support unit 107 or leg strap assemblies 102, 104 may again need adjusting prior to beginning knee extension therapy.

Referring to FIG. 4, once positioning of leg strap assembly 103 is adjusted, upper portion 149 of first strap 141 loops through first metal loop 156 of strap adjustment member 145. Patient reversibly attaches upper portion 149 to a portion of first strap 141, via hook and loop fasteners, on the opposing side of first metal loop 156 such that the positioning of patient's leg remains relatively unchanged during leg extension therapy.

As illustrated in FIG. 1 and FIG. 4, once the distal region of patient's leg is placed into leg support unit 107 and leg strap assemblies 102, 103, 104 are adjusted to maintain the positioning of the proximal and central regions of patient's leg, patient may begin knee extension therapy by engaging inflatable bladder control unit 154 such that it begins inflating inflatable bladder 110.

In the embodiments of leg support unit 107 illustrated in FIG. 2 and FIG. 4, the distal region of patient's leg rests directly on inflatable bladder 110. When patient activates inflation of inflatable bladder 110 with inflatable bladder control unit 154, inflatable bladder 110 then imparts an increase in elevation to patient's distal leg region, while at the same time leg strap assemblies 102, 103, 104 maintain the positioning of the proximal and central regions of patient's leg in an approximately static state. The process of imparting an increase in elevation to the distal region of the patient's leg, while at the same time maintaining an approximate static position of the central and proximal regions of the patient's leg, facilitates extension of the patient's knee in a manner similar to knee extension therapy aided by a physical therapy professional. Further, through reversing the inflation of inflatable bladder 110 with inflatable bladder control unit 154, the increased elevation imparted upon the distal region of patient's leg is able to be decreased. The process of imparting an increase in the elevation of the distal region of patient's leg may be repeated with inflatable bladder control unit 154. Knee extension therapy device 100 is typically used by patients who are unable to fully straighten their leg. As the distal end of the leg is raised by inflatable bladder 110, the leg is straightened and greater extension is imparted thereto. It should be appreciated that the user is in control of the amount of inflation imparted by inflatable bladder 110 and thereby in control of the amount of pressure applied to the extension limited leg.

Similarly, when an embodiment of leg support unit 107′, as illustrated in FIG. 3, is utilized, activation of inflatable bladder 110 imparts an increase in elevation on receiving unit bottom member 126 causing an increase in elevation of leg receiving unit 120. The distal region of patient's leg rests on support surface 122 of leg receiving unit 120. As inflatable bladder 110 is inflated causing an increase in the elevation of leg receiving unit 120, an increase in the elevation of the distal region of patient's leg occurs while leg strap assemblies 102, 103, 104 maintain the positioning of the proximal and central regions of patient's leg in a relatively static position. As the distal end of the leg is raised by inflatable bladder 110, the leg is straightened and greater extension is imparted thereto. Through reversing the inflation of inflatable bladder 110 with inflatable bladder control unit 154, the increased elevation imparted upon the distal region of patient's leg is able to be decreased. The process of imparting an increase in the elevation of the distal region of patient's leg may be repeated with inflatable bladder control unit 154. For the embodiments of leg support unit 107, 107′, illustrated in FIG. 2 and FIG. 3 respectively, repeating the process of imparting an increase in the elevation of the distal region of patient's leg may include tightening of leg strap assemblies 102, 103, 104 between repetitions to gain even greater extension.

The present device described herein is envisioned to perform knee extension therapy methods by which an increase in elevation is imparted upon a distal region of a patient's leg. By restricting the upward movement of other parts of the leg, knee extension is encouraged. Thus, knees having limited extension are imparted with greater extension that will remain when the leg is apart from knee extension therapy device 100. It is further envisioned that the present device described herein may perform knee extension therapy in a method by which an increase in elevation is imparted upon the distal region of a patient's leg followed by a decrease in elevation to the distal region of the patient's leg and this process is repeated in a continuous fashion. Further it is envisioned that knee extension therapy device 100 will allow users to impart an increase in elevation of the distal region of a patient's leg for a defined period of time, then slowly increase the elevation imparted upon the distal portion of patient's leg further to achieve greater knee extension.

When knee extension therapy device 100 is not in use, the inflatable bladder 110 may be deflated with inflatable bladder control unit 154. As illustrated in the embodiment of FIG. 1, affixation bracket 142 is capable of adjusting foot elevation unit 106 between a therapeutic position (illustrated in FIG. 1) and a storage position (not illustrated). When not in use, foot elevation unit 106 may be adjusted to storage position in order to allow for more compact and convenient storage. As illustrated in the embodiment of FIG. 4, inflatable bladder 110, affixed to leg receiving unit 120 by hook and loop fasteners, may be removed from leg receiving unit 120. Further, leg receiving unit 120, affixed to platform 151 by hook and loop fasteners, may be removed platform 151 to allow for more compact and convenient storage.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A knee therapy apparatus for performing knee extension of a user's leg by imparting increased elevation on a distal region of the user's leg, the apparatus comprising:
a base having a patient proximal end, a patient distal end, an upper surface, a lower surface, a first vertical side, and a second vertical side;
at least one strap assembly having a strap portion and a fastener, wherein the at least one strap assembly is affixed to at least one of the first vertical side, the second vertical side, the upper surface, and the lower surface of the base;
a distal leg elevation unit having a post unit and a leg support unit, wherein the leg support unit is supported on the post unit and includes a distal leg receiving portion having a plurality of side surfaces and a bottom surface;
an inflatable bladder including a pump, the bladder positioned within the distal leg elevation unit such that when the bladder is filled an upward force is applied to the distal region of the user's leg received within the distal leg receiving portion.

2. The knee therapy apparatus of claim 1, wherein the leg support unit further includes a framing bracket positioned beneath the inflatable bladder and further connected to the distal leg receiving unit.

3. The knee therapy apparatus of claim 1, wherein the bladder is positioned between the post unit and the leg support unit.

4. The knee therapy apparatus of claim 3, wherein filling the bladder applies a force that urges separation between the post unit and the leg support unit.

5. The knee therapy apparatus of claim 1, further including a leg containment cushion.

6. The knee therapy apparatus of claim 1, wherein the post unit has an upper region, a lower region, an outer post, and inner post and a coupler for coupling to the base.

7. The knee therapy apparatus of claim 1, wherein the bladder is located directly on the bottom surface of the distal leg receiving unit.

8. A knee therapy apparatus comprising:
a base having a patient proximal end, and a patient distal end, the patient proximal end including a seat portion;
a strap assembly having a strap and a fastener, the strap assembly being affixed the base;
a leg elevation unit coupled to the base at the patient distal end thereof, the leg elevation unit having a platform and a cradle supported on the platform, the cradle including side supports and a bottom support, the leg elevation unit further including an inflatable member and a distal leg support surface; the inflatable member including a bladder, a hose, and a pump, the pump being coupled to the bladder via the hose, the bladder positioned within the leg elevation unit such that activation of the pump imparts fluid to the bladder, the imparting of fluid to the bladder resulting in an increase in distance between the distal leg support surface and the base.

9. The apparatus of claim 8, wherein the strap assembly is readily proximally and distally moveable along the base.

10. The apparatus of claim 8, wherein the leg elevation unit is readily proximally and distally moveable along the base.

11. The apparatus of claim 8, wherein the hose is of a length such that a user seated on the seat portion is able hold the pump.

12. The apparatus of claim 8, wherein the strap assembly is infinitely adjustable.

13. The apparatus of claim 8, wherein the fastener includes hook and loop fasteners.

14. A method of imparting extension to a knee of a user including the steps of:
obtaining a knee therapy device including a base and a distal leg elevation unit;
sitting the user on the base of therapy device;
placing the distal portion of the user's leg into the distal leg elevation unit;
elevating the distal portion of the user's leg.

15. The method of claim 14, wherein the knee therapy device further includes a strap, and further including the step of placing the strap over the leg of the user to limit upward movement of the leg at the point of contact with the strap.

16. The method of claim 15, wherein the step of placing the strap is performed prior to the elevating step.

17. The method of claim 15, wherein the strap is placed over the leg at a position proximal of the user's knee.

18. The method of claim 14, wherein the step of elevating the distal portion of the user's leg includes inflating a bladder that is part of the distal leg elevation unit.

19. The method of claim 14, wherein the user effects the elevating of the user's leg other than by use of the user's leg muscles.

20. The method of claim 14, wherein the step of placing the distal portions of the user's let includes placing the distal portion of the user's leg into a cradle, and the step of elevating the distal portion of the user's leg includes inflating a bladder located within the cradle.
